(19) United States
(12) Patent Application Publication
(10) Pub. No.: US 2001/0034253 A1
(43) Pub. Date: Oct. 25, 2001

(54) Headset based on optical transmission and cellular communications system employing such a headset

(76) Inventor: Shiomo Ruschin, Herzlia (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(21) Appl. No.: 09/825,831

(22) Filed: Apr. 5, 2001

(30) Foreign Application Priority Data
Apr. 5, 2000 (IL) 135483

(51) Int. Cl. H04M 1/00

(52) U.S. Cl. 455/569; 455/41; 455/66; 455/109

(57) ABSTRACT

The present invention is a headset based on optics and more precisely fiber-optic communications for speaking into and listening via a cellular communications unit. The fiber-optic cable connects the microphone and earphone of the headpiece to the telephone. The use of optic fiber which is an electric insulator inherently avoids the conduction of radio frequency electromagnetic signal towards the head of the user's body, and therefore reduces possible harm to biological tissue in the head due to the radio frequency electromagnetic radiation.

### FIELD AND BACKGROUND OF THE INVENTION

The present invention relates to cellular telephone equipment and, in particular, it concerns a headset based on optical transmission for use with a cellular communications unit.

The huge growth in usage of wireless communications devices, and particularly cellular telephones has raised concerns about the possible health hazards of increased exposure to radio frequency electromagnetic radiation (RF). These concerns are particularly pronounced due to the typical positioning of the RF transmitter of a cellular telephone immediately adjacent to the user's head during operation.

The use of a headset has been proposed as a safety precaution. A headset is a telephone accessory which provides at least one earphone and a microphone, typically connected to the telephone by electric wires, through which the user can hear and speak, respectively, without bringing the cellular telephone and its included RF transmitter close to his or her head. It had been assumed that, due to the increased distance from the RF transmitter to the user's head, the exposure of the head to radiation would be greatly reduced.

In fact, a number of recent studies have suggested that, far from reducing exposure to radiation, the wires of the headset may actually function as an antenna or transmission line, focusing radiation towards the head.

There is therefore a need for a headset, and corresponding cellular communications system, which would ensure that radiation from a cellular telephone cannot pass along the headset wires to the user's head.

### SUMMARY OF THE INVENTION

The present invention is a headset based on an optical communications link for speaking into and listening via a cellular communications unit. The optical link, typically implemented using fiber-optic cable, connects the microphone and earphone (auricular) to the RF transmitting unit. The use of fiber-optic cable which is an electric insulator inherently avoids the conduction of radio frequency electromagnetic signal towards the head of the user's body, and therefore reduces possible harm to biological tissue in the head sue to the radio frequency electromagnetic radiation.

Thus, according to the teachings of the present invention there is provided, a cellular communications system for use by a user to communicate via a cellular communications network, the system comprising: (a) a cellular communications unit for two-way communication with the cellular communications network; (b) a headpiece including at least one earphone and a microphone, and (c) a bi-directional optical communications link associated with the cellular communications unit and the headpiece and configured to provide a communications link between the cellular communications unit and the headpiece such that the earphone produces an audio output corresponding to data received by the cellular communications unit and the cellular communications unit transmits data corresponding to an audio input received by the microphone.

According to a further feature of the present invention, the bi-directional optical communications link is the sole communications link between the cellular communications unit and the headpiece.

According to a further feature of the present invention, the bi-directional optical communications link includes at least one optic fiber deployed between the cellular communications unit and the headpiece.

According to a further feature of the present invention, the at least one optic fiber is implemented as two optic fibers.

According to a further feature of the present invention, the at least one optic fiber is implemented as a sole optic fiber.

According to a further feature of the present invention, the at least one optic fiber is implemented as at least one plastic optic fiber.

According to a further feature of the present invention, the headpiece further includes at least one battery.

According to a further feature of the present invention, the bi-directional optical communications link is configured to transfer power from the cellular communications unit to the headpiece for powering at least one electronic component within the headpiece.

There is also provided according to the teachings of the present invention, a headset for use with a cellular communications unit for bi-directional directional communication with a cellular communications network, the cellular communications unit having an electrical output for providing an audio-out signal corresponding to data received from the cellular communications network and an electrical input for receiving an audio-in signal for transmission via the cellular communications network, the headset comprising: (a) an electro-optic interface unit for connection to the cellular communications unit, the interface unit including: (i) an interface-unit optical modulator configured for receiving the audio-out signal from the cellular communications unit and generating a corresponding first optical signal, and (ii) an interface-unit optical receiver responsive to a received optical signal to generate a corresponding electrical audio-in signal to be provided to the electrical input of the cellular communications unit; (b) a headpiece including: (i) a headpiece optical receiver responsive to a received optical signal to generate a corresponding electrical driver signal, (ii) at least one earphone electrically connected so as to be driven by the driver signal to generate an audible sound. (iii) a microphone for generating an electrical microphone signal corresponding to sensed audible sounds, and (iv) a headpiece optical modulator responsive to the microphone signal to generate a corresponding second optical signal; and (c) an optic fiber connection including at least one optic fiber, the optic fiber connection being associated with the electro-optic interface unit and the headpiece and being configured to form an optical link between the interface-unit optical modulator and the headpiece optical receiver, and between the headpiece optical modulator and the interface-unit optical receiver.

According to a further feature of the present invention the optic fiber connection employs a single optic fiber to provide the optical link both between the interface-unit optical modulator and the headpiece optical receiver, and between the headpiece optical modulator and the interface-unit optical receiver.

According to a further feature of the present invention, the optic fiber connection employs a first optic fiber to provide the optical link between the interface-unit optical modulator and the headpiece optical receiver, and a second optic fiber to provide the optical link between the headpiece optical modulator and the interface-unit optical receiver

According to a further feature of the present invention, the at least one optic fiber is implemented as at least one plastic optic fiber.

According to a further feature of the present invention, the headpiece further includes at least one battery for powering the headpiece optical receiver and the headpiece optical modulator.

According to a further feature of the present invention, there is also provided an optical power transmission system configured to transfer power via the optical fiber connection to the headpiece for powering the headpiece optical receiver and the headpiece optical modulator.

According to a further feature of the present invention, the headset is substantially electrically insulated from the interface unit.

### BRIEF DESCRIPTION OF THE DRAWINGS

The invention is herein described, by way of example only, with reference to the accompanying drawings, wherein:

FIG. 1 is a schematic representation of a headset, constructed and operative according to the teachings of the present invention, used with a cellular communications unit;

FIG. 2 is a typical circuit diagram for an analog receiver for use in the headset of FIG. 1; and

FIG. 3 is a typical circuit diagram to achieve linear modulation of an LED source for use in the headset of FIG. 1.

### DESCRIPTION OF THE PREFERRED EMBODIMENTS

The present invention is a headset based on an optical communications link for use in a cellular communications system.

The principles and operation of headsets and communication systems according to the present invention may be better understood with reference to the drawings and the accompanying description.

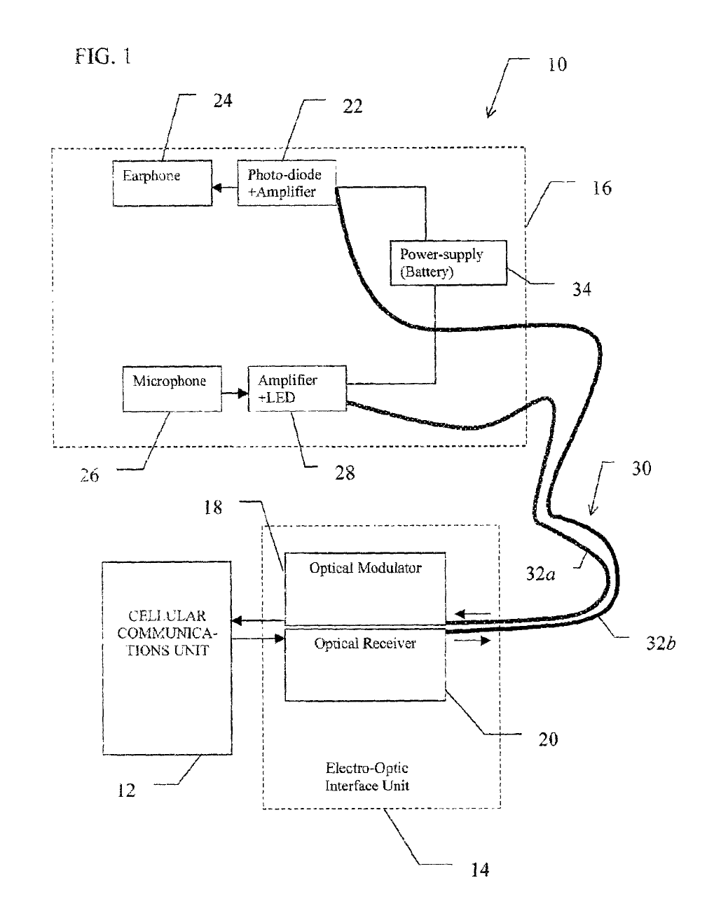

Referring now to the drawings, FIG. 1 shows schematically an implementation of a headset, generally designated 10, constructed and operative according to the teachings of the present invention, for use with a cellular communications unit 12, together forming a cellular communications system for two way communication with a cellular communications network.

Generally speaking, headset 10 may be viewed as a combination of a headpiece 16 including at least one earphone 24 and a microphone 26, and a bi-directional optical communications link, to be described in more detail below. The bi-directional optical communications link provides a communications link between cellular communications unit 12 and headpiece 16 such that the earphone produces an audio output corresponding to data received by the cellular communications unit and the cellular communications unit transmits data corresponding to an audio input received by the microphone.

It will readily be appreciated that the present invention provides a highly safe configuration in which cellular communications unit 12 can be used freely without any risk of conduction of RF towards the head of the user. Specifically, since the optical link is implemented either by use of optic fibers, which are typically effective electric insulators and cannot conduct RF radiation, or as a free-space optical link, the headset is substantially electrically insulated from the interface unit, This and other advantages of the present invention will be better understood from the following description.

It should be noted that the terms “headset” and “headpiece” are used herein in the description and claims to refer generically to any device having one or more earphone and a microphone configured for use in close proximity to the head of the user, independent of whether the device is supported directly from the head or hangs or is otherwise supported by the ear.

It should be noted that the invention can be implemented using substantially any optical communications link. Although the invention will be described herein primarily with reference to a preferred implementation using optic fibers, an open space optical communications link also falls within the scope of the invention and may be advantageous in various applications, such as, for example, in a vehicle, where an optic fiber link might be inconvenient or unsafe.

Turning now to the features of a preferred fiber-optic-based implementation of the invention in more detail, this may readily be achieved by one ordinarily skilled in the art on the basis of the illustration of FIG. 1 alone. Nevertheless, for completeness, various aspects of specific implementations will be discussed here in some more detail.

In the example illustrated, headset 10 has an electro-optic interface unit 14 for connection to cellular communications unit 12. Interface unit 14 includes an optical modulator 18 configured for receiving an audio-out signal from cellular communications unit 12 and generating a corresponding first optical signal, and an optical receiver 20 responsive to a received optical signal to generate a corresponding electrical audio-in signal to be provide dot the electrical input of cellular communications unit 12. In addition to the aforementioned at least one earphone 24 and microphone 26, headpiece 16 also includes an optical receiver 22 responsive to a received optical signal to generate a corresponding electrical driver signal for driving earphone(s) 24 to generate an audible sound. The headpiece additionally includes an optical modulator 28 responsive to an electrical microphone signal from microphone 26 to generate a corresponding second optical signal. The electro-optic interface unit and the headpiece are connected via an optic fiber connection 30 including at least one optic fiber, and in the particular implementation shown, two optical fibers 32a, 32b. Optic fiber connection 30 forms an optical link between optical modulator 18 and headpiece optical receiver 22, and between headpiece optical modulator 28 and the optical receiver 20.

As will already be clear, the headset system is physically subdivided into two assemblies: headpiece 16 and electro-optic interface unit 14. Headpiece 16 is designed in such a way that all its components are suitable to be supported adjacent to the head of the user. Electro-optic interface unit 14 is preferably connected to, or integrated with, cellular communications unit 12. More specifically, preferred implementations of electro-optic interface unit 14 include, but are not limited to, the following: (1) an “adapter” for external connection to the headset socket of a conventional cellular telephone; (2) a built-in addition located within the casing of a cellular telephone; and (3) an integral part of a dedicated cellular communications system together with a cellular communications unit which does not have any built-in microphone or speaker.

The connection between interface unit 14 and headpiece 16 according to most preferred implementations of the present invention is achieved by means of optical fibers of which both the fiber and the jacket are preferably made from electrically insulating material, such as silica, glass or plastic material (jacket). In a most preferred set of implementations, the optic fibers are implemented as plastic optical fibers, which combine low cost with optical signal transmitting performance sufficient for audio signals and short transmission range. An example of a suitable plastic optic fiber is commercially available under the tradename OptiMega™ fiber manufactured by Boston Optical Fiber, Inc. (USA).

The sound of the voice of the user actuates microphone 26, generating an electrical signal which is amplified and activates a light emitting diode (LED) 28 (for example, Marconi LD200 RCS Series) or a diode laser. The light is then coupled into fiber 32a which conducts it into interface unit 14 where it is converted back to an audio-in signal to be transmitted by cellular communications unit 12.

The audio-out signal generated by the cellular communications unit 12 is converted into an optical signal by optical modulator 18 of interface unit 20, for example, by actuating a LED. Optical fiber 32b conducts the light signal to headpiece 16, and more specifically, to a photo-diode of receiver 22, (e.g. Silicon Sensors model ST-TO-18) that generates an electrical signal, which is suitably amplified to drive earphone 24.

According to a first preferred set of implementations, one or more batteries 34 are included within headpiece 16 to power all electric and opto-electronic parts located therein. Battery 34 is chosen to be a light weight battery, such as a Li battery, since in normal use, it should be located close to the head of the user (ear and mouth) without physically burdening the user. The electrical leads from battery 34 to earphone 24, microphone 26 and the adjacent electronics are preferably kept as short as possible in order to avoid radio-frequency pick-up.

Alternatively, power for the modulator and receiver located in the headset may be provided by the cellular communications unit optically via one of the optical fibers used for linking or an additional optical fiber, allowing battery 34 to be omitted. In one possible implementation for such an alternative, the optical source included in the optical transmitter unit 18 would be powerful enough to supply the power needed to activate this headset unit 16. Further details of a suitable optical power transmission system for transferring power via the optical fiber connection to the headpiece will be clear to one ordinarily skilled in the art.

Although illustrated here with separate optic fibers 32a and 32b for transmission in each direction, it should be noted that the two optical fibers can be replaced by a single fiber which carries transmission in both directions. This requires suitable optical couplers (not shown) at each end of the single fiber, as will be clear to one ordinarily skilled in the art.

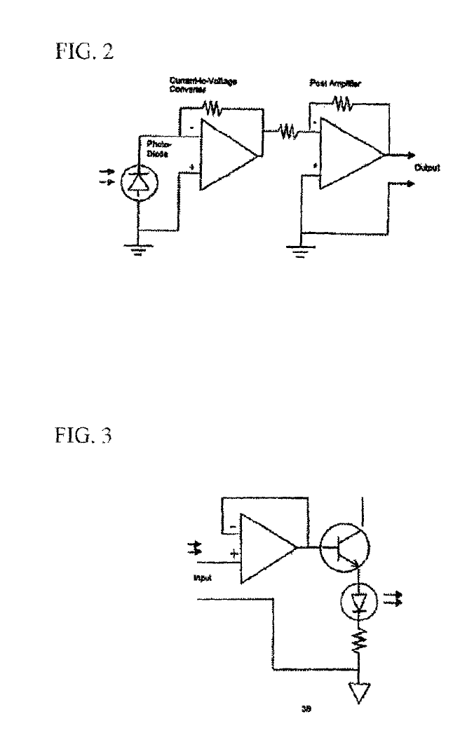

FIGS. 2 and 3 illustrate schematically suitable circuit diagrams for a receiver and a modulator, respectively, suitable for use in the present invention. The details of these circuits are generally standard, per se, and will be readily understood by one familiar with electro-optic systems. It will be clear that a more sophisticated digital communication link between the interface unit and the headpiece also falls within the scope of the present invention. It is believed, however, that the particularly simple and low cost analogue implementation described here is commercially preferable.

Finally, by way of a non-limiting example, the operation wavelength of the fiber-optic link is preferably chosen to be around 700-850 nm, since plastic optical fibers exhibit good transparency at this range. Additionally, silicon-based photo-diodes and LEDs operate at this wavelength range and are widely available at extremely low prices.

It will be appreciated that the above descriptions are intended only to serve as examples, and that many other embodiments are possible within the spirit and the scope of the present invention.

What is claimed is:

1. A cellular communications system for use by a user to communicate via a cellular communications network, the system comprising:
(a) a cellular communications unit for two-way communication with the cellular communications network;
(b) a headpiece including at least one earphone and a microphone, and
(c) a bi-directional optical communications link associated with said cellular communications unit and said headpiece and configured to provide a communications link between said cellular communications unit and said headpiece such that said earphone produces an audio output corresponding to data received by the cellular communications unit and said cellular communications unit transmits data corresponding to an audio input received by said microphone.

2. The cellular communications system of claim 1, wherein said bi-directional optical communications link is the sole communications link between said cellular communications unit and said headpiece.

3. The cellular communications system of claim 1, wherein said bi-directional optical communications link includes at least one optic fiber deployed between said cellular communications unit and said headpiece.

4. The cellular communications system of claim 3, wherein said at least one optic fiber is implemented as two optic fibers.

5. The cellular communications system of claim 3, wherein said at least one optic fiber is implemented as a sole optic fiber.

6. The cellular communications system of claim 3, wherein said at least one optic fiber is implemented as at least one plastic optic fiber.

7. The cellular communications system of claim 1, wherein said headpiece further includes at least one battery.

8. The cellular communications system of claim 1, wherein said bi-directional optical communications link is configured to transfer power from said cellular communications unit to said headpiece for powering at least one electronic component within said headpiece.

9. A headset for use with a cellular communications unit for bi-directional communication with a cellular communications network, the cellular communications unit having an electrical output for providing an audio-out signal corresponding to data received from the cellular communications network and an electrical input for receiving an audio-in signal for transmission via the cellular communications network, the headset comprising,
(a) an electro-optic interface unit for connection to the cellular communications unit, said interface unit including:
(i) an interface-unit optical modulator configured for receiving said audio-out signal from the cellular communications unit and generating a corresponding first optical signal, and
(ii) an interface-unit optical receiver responsive to a received optical signal to generate a corresponding electrical audio-in signal to be provided to the electrical input of the cellular communications unit;
(b) a headpiece including:
(i) a headpiece optical receiver responsive to a received optical signal to generate a corresponding electrical driver signal,
(ii) at least one earphone electrically connected so as to be driven by said driver signal to generate an audible sound,
(iii) a microphone for generating an electrical microphone signal corresponding to sensed audible sounds, and
(iv) a headpiece optical modulator responsive to said microphone signal to generate a corresponding second optical signal; and
(c) an optic fiber connection including at least one optic fiber, said optic fiber connection being associated with said electro-optic interface unit and said headpiece and being configured to form an optical link between said interface-unit optical modulator and said headpiece optical receiver, and between said headpiece optical modulator and said interface-unit optical receiver.

10. The headset of claim 9, wherein said optic fiber connection employs a single optic fiber to provide said optical link both between said interface-unit optical modulator and said headpiece optical receiver, and between said headpiece optical modulator and said interface-unit optical receiver.

11. The headset of claim 9, wherein said optic fiber connection employs a first optic fiber to provide said optical link between said interface unit optical modulator and said headpiece optical receiver, and a second optic fiber to provide said optical link between said headpiece optical modulator and said interface-unit optical receiver.

12. The headset of claim 9, wherein said at least one optic fiber is implemented as at least one plastic optic fiber.

13. The headset of claim 9, wherein said headpiece further includes at least one battery for powering said headpiece optical receiver and said headpiece optical modulator.

14. The headset of claim 9, further comprising an optical power transmissions system configured to transfer power via said optical fiber connection to said headpiece for powering said headpiece optical receiver and said headpiece optical modulator.

15. The headset of claim 9, wherein said headset is substantially electrically insulated from said interface unit.
